(19) United States
(12) Patent Application Publication
(10) Pub. No.: US 2018/0357239 A1
(43) Pub. Date: Dec. 13, 2018

(54) Information Retrieval Based on Views Corresponding to a Topic

(71) Applicant: Microsoft Technology Licensing, LLC, Redmond, WA (US)

(72) Inventors: Omar ALONSO, Redwood City, CA (US); Serge-Eric TREMBLAY, Pullman, WA (US); Vasileios KANDYLAS, Sunnyvale, CA (US)

(73) Assignee: Microsoft Technology Licensing, LLC, Redmond, WA (US)

(21) Appl. No.: 15/616,541

(22) Filed: Jun. 7, 2017

(51) Int. Cl. G06F 17/30

(52) U.S. Cl. CPC G06F 17/3053; G06F 3/0481; G06F 17/30554; G06F 17/30598

(57) ABSTRACT

A system for retrieving information can include a processor that can identify a topic of information in a data repository as a polarized topic based on a degree of conflict related to the topic. The processor can also detect a plurality of views corresponding to the polarized topic based in part on a temporal relationship to an event, independent of a frequency of occurrence of the plurality of views. Furthermore, the processor can generate a user interface based on an organization of the plurality of views corresponding to the polarized topic, the user interface being organized to show multiple perspectives on the polarized topic by including at least one of the plurality of views independent of the frequency of occurrence.

### BACKGROUND

As the number of sources for information increases, it is difficult to determine a bias or viewpoint associated with each piece of information. For example, a source for information may promote a particular view or set of views. In some examples, sources for information can prevent opposing views or sets of views from being discussed or distributed.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

An embodiment described herein includes a system for retrieving information that can include a processor and a memory device coupled to the processor, the memory device to store instructions that, in response to being executed by the processor, cause the processor to identify a topic of information in a data repository as a polarized topic based on a degree of conflict related to the topic. The processor can also detect a plurality of views corresponding to the polarized topic based in part on a temporal relationship to an event independent of a frequency of occurrence of the plurality of views. Additionally, the processor can generate a user interface based on an organization of the plurality of views corresponding to the polarized topic, the user interface being organized to show multiple perspectives on the polarized topic by including at least one of the plurality of views independent of the frequency of occurrence.

In another embodiment described herein, a method for retrieving information, can include identifying a topic of information in a data repository as a polarized topic based on a degree of conflict related to the topic. The method can also include detecting a plurality of views corresponding to the polarized topic based in part on a temporal relationship to an event independent of a frequency of occurrence of the plurality of views. Furthermore, the method can include generating a user interface based on an organization of the plurality of views corresponding to the polarized topic, the user interface being organized to show multiple perspectives on the polarized topic by including at least one of the plurality of views independent of the frequency of occurrence.

In yet another embodiment described herein, one or more computer-readable storage devices for retrieving information can include a plurality of instructions that, based at least on execution by a processor, cause the processor to identify a topic of information in a data repository as a polarized topic based on a degree of conflict related to the topic. The plurality of instructions can also cause the processor to detect a plurality of views corresponding to the polarized topic based in part on a temporal relationship to an event independent of a frequency of occurrence of the plurality of views. Furthermore, the plurality of instructions can cause the processor to generate a user interface based on an organization of the plurality of views corresponding to the polarized topic, the user interface being organized to show multiple perspectives on the polarized topic by including at least one of the plurality of views independent of the frequency of occurrence.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of an example of a computing system that can retrieve information based on several views corresponding to a polarized topic;

FIG. 2 is a diagram illustrating a user interface for providing information based on several views corresponding to a polarized topic;

FIG. 3 is a process flow diagram of an example method for retrieving information based on several views corresponding to a polarized topic; and

FIG. 4 is a block diagram of an example computer-readable storage media that can retrieve information based on several views corresponding to a polarized topic.

### DETAILED DESCRIPTION

Techniques described herein provide a system for retrieving information based on several views corresponding to a polarized topic. A polarized topic, as referred to herein, can include any topic associated with strong emotions or reactions. For example, a polarized topic can include any number of controversial topics with at least two strongly opposed opinions or views. In some embodiments, the techniques include retrieving information pertaining to various views for each polarized topic. For example, a system can detect a query and generate results from any suitable data repository, wherein the results present multiple views corresponding to a polarized topic included in the query.

In some embodiments, a system for retrieving information based on several views corresponding to a polarized topic can include a processor that can identify a topic of information in a data repository as a polarized topic based on a degree of conflict related to the topic. The processor can also detect a plurality of views corresponding to the polarized topic based in part on a temporal relationship to an event, wherein the plurality of views are independent of a frequency of occurrence. Additionally, the processor can generate a user interface based on an organization of the plurality of views corresponding to the polarized topic. In some examples, the user interface can be organized to show multiple perspectives on the polarized topic by including at least one of the plurality of views independent of the frequency of occurrence. Accordingly, the techniques described herein enable a user to view a plurality of opposing or different views corresponding to a polarized topic.

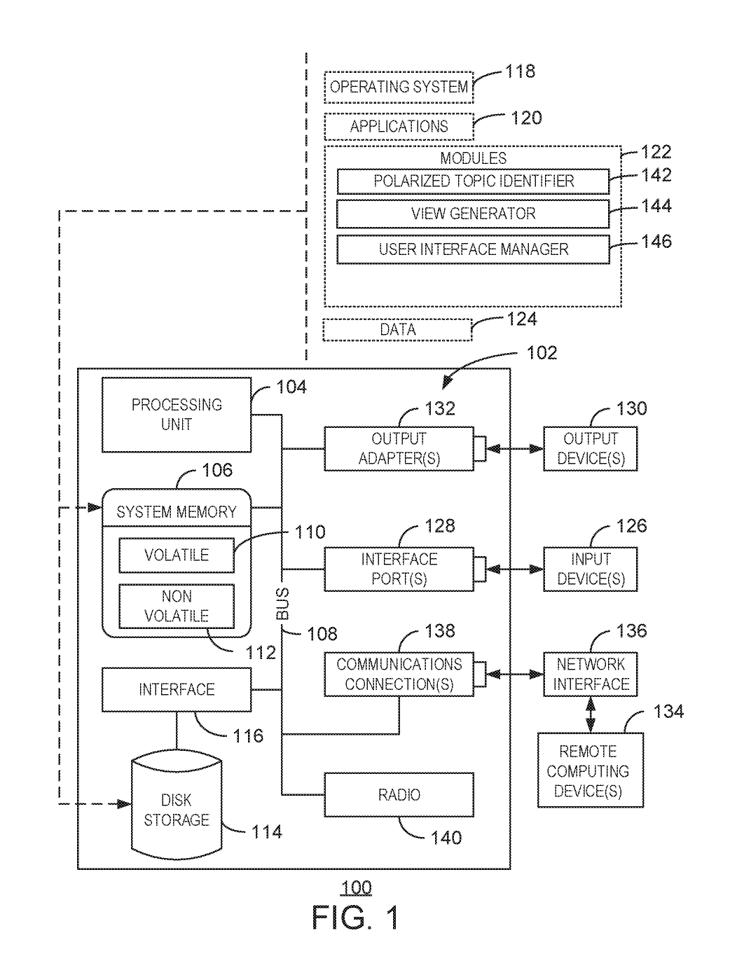

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1 discussed below, provide details regarding different systems that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like.

FIG. 1 is a block diagram of an example of a computing system that can retrieve and provide information based on several views corresponding to a polarized topic. The example system 100 includes a computing device 102. The computing device 102 includes a processing unit 104, a system memory 106, and a system bus 108. In some examples, the computing device 102 can be a gaming console, a personal computer (PC), an accessory console, a gaming controller, among other computing devices. In some examples, the computing device 102 can be a node in a cloud network.

The system bus 108 couples system components including, but not limited to, the system memory 106 to the processing unit 104. The processing unit 104 can be any of various available processors. Dual microprocessors and other multiprocessor architectures also can be employed as the processing unit 104.

The system bus 108 can be any of several types of bus structure, including the memory bus or memory controller, a peripheral bus or external bus, and a local bus using any variety of available bus architectures known to those of ordinary skill in the art. The system memory 106 includes computer-readable storage media that includes volatile memory 110 and nonvolatile memory 112.

The basic input/output system (BIOS), containing the basic routines to transfer information between elements within the computer 102, such as during start-up, is stored in nonvolatile memory 112. By way of illustration, and not limitation, nonvolatile memory 112 can include read-only memory (ROM), programmable ROM (PROM), electrically programmable ROM (EPROM), electrically erasable programmable ROM (EEPROM), or flash memory.

Volatile memory 110 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 102 also includes other computer-readable media, such as removable/non-removable, volatile/non-volatile computer storage media. FIG. 1 shows, for example a disk storage 114. Disk storage 114 includes, but is not limited to, devices like a magnetic disk drive, floppy disk drive, tape drive, Jaz drive, Zip drive, LS-210 drive, flash memory card, or memory stick.

In addition, disk storage 114 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 114 to the system bus 108, a removable or non-removable interface is typically used such as interface 116.

It is to be appreciated that FIG. 1 describes software that acts as an intermediary between users and the basic computer resources described in the suitable operating environment 100. Such software includes an operating system 118. Operating system 118, which can be stored on disk storage 114, acts to control and allocate resources of the computer 102.

System applications 120 take advantage of the management of resources by operating system 118 through program modules 122 and program data 124 stored either in system memory 106 or on disk storage 114. It is to be appreciated that the disclosed subject matter can be implemented with various operating systems or combinations of operating systems.

A user enters commands or information into the computer 102 through input devices 126. Input devices 126 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, any suitable dial accessory (physical or virtual), and the like. In some examples, an input device can include Natural User Interface (NUI) devices. NUI refers to any interface technology that enables a user to interact with a device in a “natural” manner, free from artificial constraints imposed by input devices such as mice, keyboards, remote controls, and the like. In some examples, NUI devices include devices relying on speech recognition, touch and stylus recognition, gesture recognition both on screen and adjacent to the screen, air gestures, head and eye tracking, voice and speech, vision, touch, gestures, and machine intelligence. For example, NUI devices can include touch sensitive displays, voice and speech recognition, intention and goal understanding, and motion gesture detection using depth cameras such as stereoscopic camera systems, infrared camera systems, RGB camera systems and combinations of these. NUI devices can also include motion gesture detection using accelerometers or gyroscopes, facial recognition, three-dimensional (3D) displays, head, eye, and gaze tracking, immersive augmented reality and virtual reality systems, all of which provide a more natural interface. NUI devices can also include technologies for sensing brain activity using electric field sensing electrodes. For example, a NUI device may use Electroencephalography (EEG) and related methods to detect electrical activity of the brain. The input devices 126 connect to the processing unit 104 through the system bus 108 via interface ports 128. Interface ports 128 include, for example, a serial port, a parallel port, a game port, and a universal serial bus (USB).

Output devices 130 use some of the same type of ports as input devices 126. Thus, for example, a USB port may be used to provide input to the computer 102 and to output information from computer 102 to an output device 130.

Output adapter 132 is provided to illustrate that there are some output devices 130 like monitors, speakers, and printers, among other output devices 130, which are accessible via adapters. The output adapters 132 include, by way of illustration and not limitation, video and sound cards that provide a means of connection between the output device 130 and the system bus 108. It can be noted that other devices and systems of devices provide both input and output capabilities such as remote computing devices 134.

The computer 102 can be a server hosting various software applications in a networked environment using logical connections to one or more remote computers, such as remote computing devices 134. The remote computing devices 134 may be client systems configured with web browsers, PC applications, mobile phone applications, and the like. The remote computing devices 134 can be a personal computer, a server, a router, a network PC, a workstation, a microprocessor based appliance, a mobile phone, a peer device or other common network node and the like, and typically includes many or all of the elements described relative to the computer 102.

Remote computing devices 134 can be logically connected to the computer 102 through a network interface 136 and then connected via a communication connection 138, which may be wireless. Network interface 136 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 138 refers to the hardware/software employed to connect the network interface 136 to the bus 108. While communication connection 138 is shown for illustrative clarity inside computer 102, it can also be external to the computer 102. The hardware/software for connection to the network interface 136 may include, for exemplary purposes, internal and external technologies such as, mobile phone switches, modems including regular telephone grade modems, cable modems and DSL modems, ISDN adapters, and Ethernet cards.

The computer 102 can further include a radio 140. For example, the radio 140 can be a wireless local area network radio that may operate one or more wireless bands. For example, the radio 140 can operate on the industrial, scientific, and medical (ISM) radio band at 2.4 GHz or 5 GHz. In some examples, the radio 140 can operate on any suitable radio band at any radio frequency.

The computer 102 includes one or more modules 122, such as a polarized topic identifier 142, a view generator 144, and a user interface manager 146. In some embodiments, the polarized topic identifier 142 can identify a topic of information in a data repository as a polarized topic based on a degree of conflict related to the topic. In some embodiments, the view generator 144 can detect a plurality of views corresponding to the polarized topic based in part on a temporal relationship to an event and independent of a frequency of occurrence of the plurality of views. Additionally, the user interface manager 146 can generate a user interface based on an organization of the plurality of views corresponding to the polarized topic. In some examples, the user interface manager 146 can be organized to show multiple perspectives on the polarized topic by including at least one of the plurality of views independent of the frequency of occurrence.

It is to be understood that the block diagram of FIG. 1 is not intended to indicate that the computing system 102 is to include all of the components shown in FIG. 1. Rather, the computing system 102 can include fewer or additional components not illustrated in FIG. 1 (e.g., additional applications, additional modules, additional memory devices, additional network interfaces, etc.). Furthermore, any of the functionalities of the polarized topic identifier 142, view generator 144, and user interface manager 146 may be partially, or entirely, implemented in hardware and/or in the processing unit (also referred to herein as a processor) 104. For example, the functionality may be implemented with an application specific integrated circuit, in logic implemented in the processing unit 104, or in any other device.

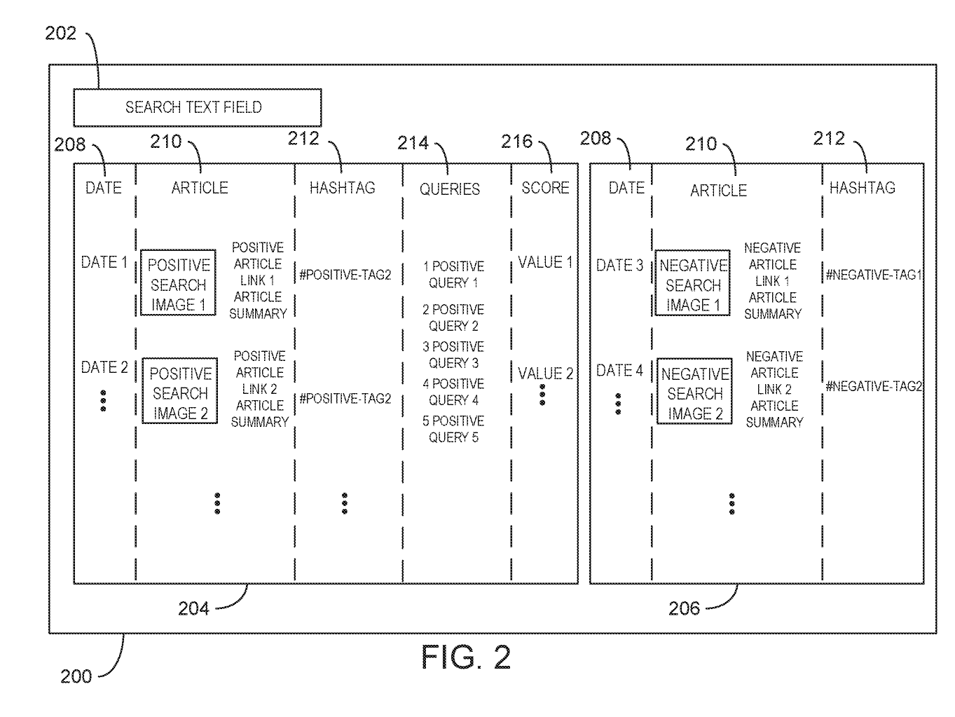

FIG. 2 is a diagram illustrating a user interface for providing information based on several views corresponding to a polarized topic. In some embodiments, user interface 200 can include any suitable number of control elements such as text fields, labels, buttons, check boxes, and the like. The control elements can enable users to provide any suitable input. In some examples, the user interface 200 can include a control element such as a search text field 202 that can detect user input corresponding to the user interface 200. For example, the search text field 202 can detect input characters from a software keyboard or a hardware keyboard.

In some embodiments, the user interface 200 can include any suitable number of columns corresponding to different views for a topic. For example, the user interface 200 can include two columns 204 and 206 corresponding to opposing views of a topic entered into the search text field 202. Each column 204 and 206 can include various fields such as a date field 208, an article field 210, a hashtag field 212, a queries field 214, and a score field 216. In some embodiments, each column 204 and 206 includes the same fields 208-216.

In some embodiments, the date field 208 can correspond to a date of publication of the article referenced in the article field 210. In some examples, the articles are related close in time to an event or topic entered in the search text field 202. For example, a search for an event or a topic pertaining to a sports team may result in articles published soon after the last game of the sports team. Similarly, searches for other topics, such as elections, among others, can provide articles that are published shortly after an election or any other suitable event. The article field 210 can include a list of articles related to a view for a topic. For example, the article field 210 can be populated with positive articles or negative articles corresponding to a topic. In some examples, the article field 210 can also include a search image, a link to the article, and an article summary corresponding to each article. In some embodiments, the hashtag field 212 can indicate a list of hashtags corresponding to each article in the article title field 210. For example, the hashtag field 212 can indicate hashtags that support the view of the article. In some examples, the hashtag field 212 is populated by analyzing social media posts and computing a frequency of similar social media posts. In some embodiments, detecting two or more similar social media posts that contain different hashtags can indicate potentially different views if the hashtags are semantically different. In some examples, the hashtag field 212 can include any re-query such as a hashtag, an n-gram, and the like. A hashtag can be detected from a specific discussion group, while an n-gram may be detected based on negative terms that appear in similar content. In some embodiments, the queries field 214 can indicate queries that are related to each listed article. In some examples, queries can be derived by extracting a signature of a link from a social media post or a contextual vector of a hashtag. In some examples, signatures and contextual vectors can include lists of terms that describe an article link or a hashtag. The signatures and contextual vectors can be identified based on terms that are distinctive and closely associated with an article's link or a hashtag. For example, a hashtag for a sports team may include various names and aliases of the sports team, events associated with the sports team, and the like. In some embodiments, the score field 216 can provide any suitable numeric value indicating a strength of relationship between a view and each listed article. For example, a higher score value may indicate that an article strongly supports a particular view on a topic and is not objective. In some embodiments, a number of times a particular n-gram or topic co-occurs with a hashtag or entity (e.g., name, people, place, etc.) can be used to measure the strength of an article in support or in opposition to a view and indicate a score.

In some embodiments, the two columns 204 and 206 of the user interface 200 include data fields 208, article fields 210, hashtag fields 212, query fields 214, and score fields 216. Each of the columns 204 and 206 can include any number of articles that support each view corresponding to each column 204 and 206. For example, column 204 depicts example articles that correspond to a positive view of a topic entered into the search text field 202. Accordingly, column 204 lists links to positive article 1 and positive article 2, positive search image 1 and positive search image 2, positive hashtag 1 and positive hashtag 2, positive queries 1, 2, 3, 4, and 5, and values 1 and 2 corresponding to the scores of the positive views of the articles.

By contrast, column 206 depicts example articles that correspond to a negative view of a topic entered into the search text field 202. Accordingly, column 206 lists links to negative article 1 and negative article 2, negative search image 1 and negative search image 2, negative hashtag 1 and negative hashtag 2, negative queries 1, 2, 3, 4, and 5, and values 1 and 2 corresponding to scores for the negative view of the articles. In some embodiments, a top number of articles that are the most viewed or most related to a topic entered into the search text field 202 may correspond to a positive view or a negative view. The user interface 200 can promote articles to enable a user to view the top articles pertaining to each view. For example, the most popular or closely related negative article to a topic entered into the search text field 202 can be displayed as the top article in column 206 even if ten or more articles corresponding to a positive view of the topic are more popular or deemed more closely related to the topic.

In some embodiments, positive and negative articles can be intermixed, so that a single search result list is shown. In some examples, some articles that previously would not have been included in the single search result list because of low user engagement or frequency of occurrence can be boosted or promoted to a higher position. The promoted articles can appear in a first page of search results because the articles contain opposing viewpoints to the other results. In some embodiments, a perspective or view can be displayed with each search result. For example, the user interface 200 can show or display a shortcut or re-query or entry point to other views or perspectives proximate a search result. Accordingly, the user interface 200 may indicate search results for a single view, but the user interface 200 may provide entry points for other views or preview other views corresponding to each search result.

In another example, when searching for a polarized topic via a search engine, search results may be displayed on one side of a user interface 200 and on another side of the user interface 200, a summary of the opposing views may be displayed. Alternatively, each of the articles listed in the search results could be tagged with the view that the article supports if the article has a clear positive or negative view.

It is to be understood that the block diagram of FIG. 2 is not intended to indicate that the user interface 200 is to include all of the components shown in FIG. 2. Rather, user interface 200 can include fewer or additional components not illustrated in FIG. 2. In some embodiments, the user interface 200 can also include a column listing example posts from social media that support a positive or a negative view. In some embodiments, the user interface 200 can display views pertaining to a topic that may not be positive and negative. Rather, the user interface 200 may display opposing views for a topic such as opposing political views, among others.

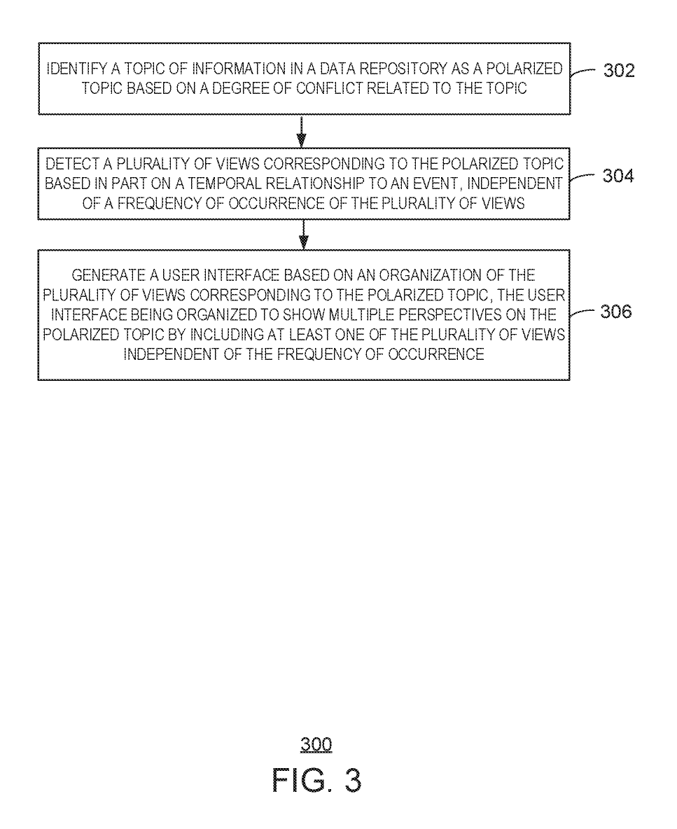

FIG. 3 is a process flow diagram of an example method for retrieving information based on several views corresponding to a polarized topic. The method 300 can be implemented with any suitable computing device, such as the computing system 102 of FIG. 1.

At block 302, a polarized topic identifier 142 can identify a topic of information in a data repository as a polarized topic based on a degree of conflict related to the topic. In some embodiments, the data repository can include social media comments, web search results, or a document repository, among others. In some examples, the data repository can be a local collection of data or the data repository can reside on any number of remote computing devices. In some examples, the polarized topic identifier 142 can determine the degree of conflict for a topic by monitoring social media statistics related to the topic, detecting a number of search queries related to the topic, and the like. For example, the polarized topic identifier 142 can detect articles, social media posts, comments, and the like, with strong or negative sentiment. The polarized topic identifier 142 can also determine if multiple articles relate to strong sentiment for a topic and if multiple articles relate to negative sentiment for a topic. In some examples, the polarized topic identifier 142 can use machine learning techniques for topic modeling and identifying polarized topics, wherein the machine learning techniques can include TF-IDF, latent semantic analysis (LSA), independent component analysis (ICA), or latent Dirichlet allocation (LDA), among others. In some embodiments, the polarized topic identifier 142 can compute the sentiment of the article, social medial post, or comment based on the use of strong or controversial topics. In some embodiments, the polarized topic identifier 142 can identify additional polarized topics based on a previously detected polarized topic. As discussed below, the techniques described herein can also include determining how various articles or social media posts are positioned with regard to a particular view.

In some embodiments, the polarized topic identifier 142 can also detect information about the authors of the articles or posts. For example, the polarized topic identifier 142 can determine a bias associated with particular authors and combine the author's known bias with the previous analysis. The polarized topic identifier 142 can then associate polarized topics and articles or social media posts from authors with known biases. In some examples, the polarized topic identifier 142 can also detect a temporal bias for an author indicating that an author's bias has shifted between views over time. For example, an author may support a first view for a period of time and later support a second opposing view. The polarized topic identifier 142 can associate information published by an author with a particular view based on a time of the publication of the information and the temporal bias of the author at the time of the publication. In some embodiments, the polarized topic identifier 142 can monitor topics discussed in comments on social media websites or applications and determine that topics that correspond to comments with positive terms and comments with negative terms are polarized. In some embodiments, the polarized topic identifier 142 can detect topics that are polarized based on sentiment, emotions, agreement, division, controversy, and the like.

At block 304, a view generator 144 can detect a plurality of views corresponding to the polarized topic based in part on a temporal relationship to an event, independent of a frequency of occurrence of the plurality of views. In some embodiments, the view generator 144 can detect any suitable number of views corresponding to each topic. An event, as referred to herein, can include any suitable occurrence that results in a generation of articles, social media posts, and the like. For example, an event can include an election, a sporting event, a debate, or any suitable action that generates news, and the like. In some embodiments, the view generator 144 can detect views based on an event. For example, the view generator 144 can detect any number of articles or social media posts, which are generated close in time to an event. In some examples, the views can correspond to different social media comments or different websites related to web search results for a topic. The views can indicate more than positive versus negative views. Rather, the views can indicate various opinions supported by a group of individuals that exceeds a threshold number of members. In some embodiments, the view generator 144 can aggregate public, private, and anonymous information to detect views. In some examples, the public information can correspond to publicly available social media posts, private information can correspond to social media posts viewable by a limited number of users, and anonymous information can include comments by alias users provided in relation to articles or social media posts. In some examples, the view generator 144 can prevent access to private social media comments so that views in private social media accounts are not included in a list of views for a topic. In some examples, the view generator 144 can detect the views for a topic using any suitable machine learning technique.

At block 306, a user interface manager 146 can generate a user interface based on an organization of the plurality of views corresponding to the polarized topic. In some examples, the user interface can be organized to show multiple perspectives on the polarized topic by including at least one of the plurality of views independent of the frequency of occurrence. In some embodiments, the user interface manager 146 can display content pertaining to views that are not selected as frequently as other views. For example, the user interface manager 146 can provide a user interface that displays content for opposing views by promoting content related to views that are less popular or lower within web search results. For example, the user interface manager 146 can detect that a top number of articles related to a polarized topic correspond to a first view. The user interface manager 146 can promote articles related to a second view of the polarized topic to be displayed alongside the articles related to the first view. In some embodiments, the user interface manager 146 can detect a level or score indicating how controversial or polarizing a topic is. The user interface manager 146 can provide content related to positive and negative views with a comparable level or score. For example, the user interface manager 146 can provide extremely negative content for a first view related to a topic and extremely positive content for a second view related to the same topic.

In some embodiments, the user interface manager 146 can configure a number of views to be displayed for each topic based on predetermined number or a preference for particular sources of views. In some embodiments, the user interface manager 146 can display a preferred view for a user based on a user's history on one side of a user interface and additional views can be displayed on another side of the user interface. In some examples, the user interface manager 146 can detect that content associated with some views corresponds to a particular author that is to be blocked or ignored. In some embodiments, the user interface manager 146 can separate views into a predetermined number of columns, wherein each column displays comments, articles, documents, and the like pertaining to a particular view for a topic. For example, the user interface manager 146 can determine that a topic that has three separate groups of views and display information related to each of the views in three separate columns. In some examples, the user interface manager 146 can display a single column or list of articles and social media comments related to a topic, wherein the different views for the topic are mixed. For example, the user interface manager 146 can indicate a view of each article based on a highlighting color, or an annotation, among others. In some embodiments, the user interface manager 146 can provide content for the views for a topic using audio results. In some examples, the user interface manager 146 may detect that a topic has a controversial rating or score above a threshold value and avoid providing humorous content along with the audio results from a digital assistant. In some examples, a digital assistant can also provide a view in an audio format corresponding to a search result or article.

In some embodiments, the user interface manager 146 can also recommend related sub-topics to a user based on a user's search history. For example, the user interface manager 146 can detect sub-topics related to a topic being displayed and determine the sub-topics based on a user's previous search queries. In some embodiments, the user interface manager 146 can display views corresponding to sub-topics based on a user's search history if a topic is determined to be broad. For example, the user interface manager 146 can determine that a topic corresponding to an election may include a number of sub-topics that exceed a threshold number. In some examples, the user interface manager 146 can select sub-topics to be displayed based on the user's search history. For example, the user interface manager 146 may display sub-topics related to the economy rather than all sub-topics related to a topic searched by a user.

In one embodiment, the process flow diagram of FIG. 3 is intended to indicate that the blocks of the method 300 are to be executed in a particular order. Alternatively, in other embodiments, the blocks of the method 300 can be executed in any suitable order and any suitable number of the blocks of the method 300 can be included. Further, any number of additional blocks may be included within the method 300, depending on the specific application. In some embodiments, the method 300 can include populating a list of views for each topic prior to enabling a generation of a user interface. In some embodiments, one of a plurality of views chosen independent of the frequency of occurrence is displayed as a recommendation for further study. In some embodiments, the polarized topic comprises a political topic or a religious topic. In some embodiments, a user interface is to display at least two of the plurality of views, wherein the at least two views are opposing views. In some embodiments, a user interface manager 146 can promote lower ranked views or search results. In some embodiments, the user interface manager 146 can block at least one of the plurality of views based on an author of the view. In some embodiments, the method 300 can include monitoring views for a topic to enable continuously updating the views to be displayed with each topic.

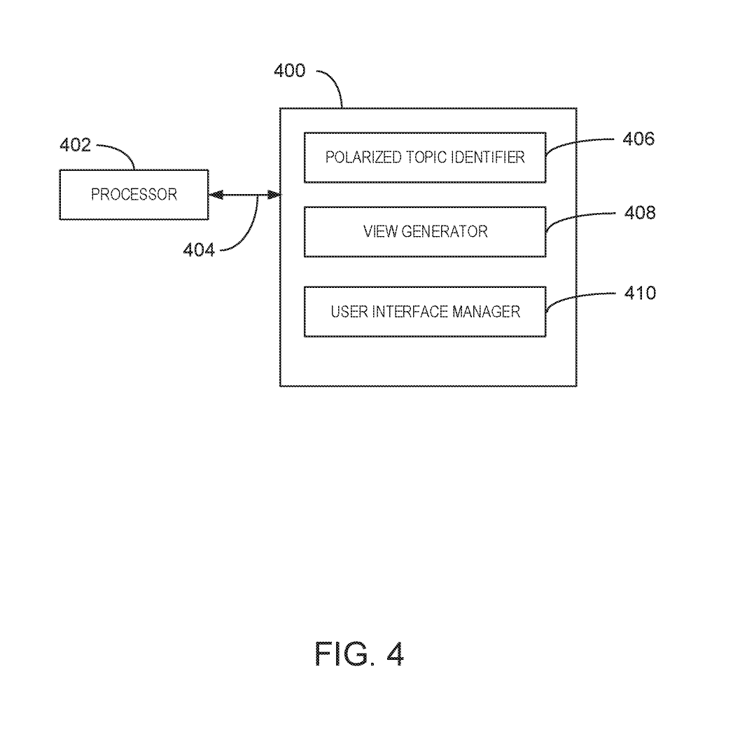

FIG. 4 is a block diagram of an example computer-readable storage media that can retrieve information for several views corresponding to a polarized topic. The tangible, computer-readable storage media 400 may be accessed by a processor 402 over a computer bus 404. Furthermore, the tangible, computer-readable storage media 400 may include code to direct the processor 402 to perform the steps of the current method.

The various software components discussed herein may be stored on the tangible, computer-readable storage media 400, as indicated in FIG. 4. For example, the tangible computer-readable storage media 400 can include a polarized topic identifier 406 that can identify a topic of information in a data repository as a polarized topic based on a degree of conflict related to the topic. In some embodiments, a view generator 408 can detect a plurality of views corresponding to the polarized topic based in part on a temporal relationship to an event, independent of a frequency of occurrence of the plurality of views. Additionally, a user interface manager 410 can generate a user interface based on an organization of the plurality of views corresponding to the polarized topic. In some examples, the user interface manager 410 can be organized to show multiple perspectives on the polarized topic by including at least one of the plurality of views independent of the frequency of occurrence.

It is to be understood that any number of additional software components not shown in FIG. 4 may be included within the tangible, computer-readable storage media 400, depending on the specific application.

### EXAMPLE 1

In one embodiment, a system for retrieving information can include a processor and a memory device coupled to the processor, the memory device to store instructions that, in response to being executed by the processor, cause the processor to identify a topic of information in a data repository as a polarized topic based on a degree of conflict related to the topic. The processor can also detect a plurality of views corresponding to the polarized topic based in part on a temporal relationship to an event independent of a frequency of occurrence of the plurality of views. Additionally, the processor can generate a user interface based on an organization of the plurality of views corresponding to the polarized topic, the user interface being organized to show multiple perspectives on the polarized topic by including at least one of the plurality of views independent of the frequency of occurrence.

Alternatively, or in addition, the processor can identify the polarized topic in part based on public, private and/or anonymous information. Alternatively, or in addition, the processor can display one of the plurality of views chosen independent of the frequency of occurrence as a recommendation for further study. Alternatively, or in addition, the polarized topic comprises a political topic or a religious topic. Alternatively, or in addition, the processor can display the user interface with at least two of the plurality of views, wherein the at least two views are opposing views. Alternatively, or in addition, the processor can promote lower ranked views. Alternatively, or in addition, the processor can block at least one of the plurality of views based on an author of the view. Alternatively, or in addition, the processor can provide at least one of the views in an audio format with a digital assistant.

### EXAMPLE 2

In another embodiment described herein, a method for retrieving information, can include identifying a topic of information in a data repository as a polarized topic based on a degree of conflict related to the topic. The method can also include detecting a plurality of views corresponding to the polarized topic based in part on a temporal relationship to an event independent of a frequency of occurrence of the plurality of views. Furthermore, the method can include generating a user interface based on an organization of the plurality of views corresponding to the polarized topic, the user interface being organized to show multiple perspectives on the polarized topic by including at least one of the plurality of views independent of the frequency of occurrence.

Alternatively, or in addition, the method can include identifying the polarized topic in part based on public, private and/or anonymous information. Alternatively, or in addition, the method can include displaying one of the plurality of views chosen independent of the frequency of occurrence as a recommendation for further study. Alternatively, or in addition, the polarized topic comprises a political topic or a religious topic. Alternatively, or in addition, the method can include displaying the user interface with at least two of the plurality of views, wherein the at least two views are opposing views. Alternatively, or in addition, the method can include promoting lower ranked views. Alternatively, or in addition, the method can include blocking at least one of the plurality of views based on an author of the view. Alternatively, or in addition, the method can include providing at least one of the views in an audio format with a digital assistant.

### EXAMPLE 3

In yet another embodiment described herein, one or more computer-readable storage devices for retrieving information can include a plurality of instructions that, based at least on execution by a processor, cause the processor to identify a topic of information in a data repository as a polarized topic based on a degree of conflict related to the topic. The plurality of instructions can also cause the processor to detect a plurality of views corresponding to the polarized topic based in part on a temporal relationship to an event independent of a frequency of occurrence of the plurality of views. Furthermore, the plurality of instructions can cause the processor to generate a user interface based on an organization of the plurality of views corresponding to the polarized topic, the user interface being organized to show multiple perspectives on the polarized topic by including at least one of the plurality of views independent of the frequency of occurrence.

Alternatively, or in addition, the plurality of instructions can cause the processor to identify the polarized topic in part based on public, private and/or anonymous information. Alternatively, or in addition, the plurality of instructions can cause the processor to display one of the plurality of views chosen independent of the frequency of occurrence as a recommendation for further study. Alternatively, or in addition, the polarized topic comprises a political topic or a religious topic. Alternatively, or in addition, the plurality of instructions can cause the processor to display the user interface with at least two of the plurality of views, wherein the at least two views are opposing views that are displayed based on a user's history. Alternatively, or in addition, the plurality of instructions can cause the processor to promote lower ranked views. Alternatively, or in addition, the plurality of instructions can cause the processor to block at least one of the plurality of views based on an author of the view. Alternatively, or in addition, the plurality of instructions can cause the processor to provide at least one of the views in an audio format with a digital assistant.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for retrieving information, comprising:
a processor; and
a memory device coupled to the processor, the memory device to store instructions that, in response to being executed by the processor, cause the processor to:
identify a topic of information in a data repository as a polarized topic based on a degree of conflict related to the topic;
detect a plurality of views corresponding to the polarized topic based in part on a temporal relationship to an event, independent of a frequency of occurrence of the plurality of views; and
generate a user interface based on an organization of the plurality of views corresponding to the polarized topic, the user interface being organized to show multiple perspectives on the polarized topic by including at least one of the plurality of views independent of the frequency of occurrence.

2. The system of claim 1, wherein the processor is to identify the polarized topic in part based on public, private and/or anonymous information.

3. The system of claim 1, wherein the processor is to display one of the plurality of views chosen independent of the frequency of occurrence as a recommendation for further study.

4. The system of claim 1, wherein the polarized topic comprises a political topic or a religious topic.

5. The system of claim 1, wherein the processor is to display the user interface with at least two of the plurality of views, wherein the at least two views are opposing views.

6. The system of claim 1, wherein the processor is to promote lower ranked views.

7. The system of claim 1, wherein the processor is to block at least one of the plurality of views based on an author of the view.

8. The system of claim 1, wherein the processor is to provide at least one of the views in an audio format with a digital assistant.

9. A method for retrieving information, comprising:
identifying a topic of information in a data repository as a polarized topic based on a degree of conflict related to the topic;
detecting a plurality of views corresponding to the polarized topic based in part on a temporal relationship to an event, independent of a frequency of occurrence of the plurality of views; and
generating a user interface based on an organization of the plurality of views corresponding to the polarized topic, the user interface being organized to show multiple perspectives on the polarized topic by including at least one of the plurality of views independent of the frequency of occurrence.

10. The method of claim 9, wherein the polarized topic is identified in part based on public, private and/or anonymous information.

11. The method of claim 9, wherein one of the plurality of views chosen independent of the frequency of occurrence is displayed as a recommendation for further study.

12. The method of claim 9, wherein the polarized topic comprises a political topic or a religious topic.

13. The method of claim 9, wherein the user interface is to display at least two of the plurality of views, wherein the at least two views are opposing views.

14. The method of claim 9, comprising promoting lower ranked views.

15. The method of claim 9, comprising blocking at least one of the plurality of views based on an author of the view.

16. One or more computer-readable storage devices storing a plurality of instructions that, in response to being executed by a processor, cause the processor to:
identify a topic of information in a data repository as a polarized topic based on a degree of conflict related to the topic;
detect a plurality of views corresponding to the polarized topic based in part on a temporal relationship to an event, independent of a frequency of occurrence of the plurality of views; and
generate a user interface based on an organization of the plurality of views corresponding to the polarized topic, the user interface being organized to show multiple perspectives on the polarized topic by including at least one of the plurality of views independent of the frequency of occurrence.

17. The one or more computer-readable storage devices of claim 16, wherein the plurality of instructions cause the processor to identify the polarized topic in part based on public, private and/or anonymous information.

18. The one or more computer-readable storage devices of claim 16, wherein the plurality of instructions cause the processor to display one of the plurality of views chosen independent of the frequency of occurrence as a recommendation for further study.

19. The one or more computer-readable storage devices of claim 16, wherein the plurality of instructions cause the processor to display the user interface with at least two of the plurality of views, wherein the at least two views are opposing views that are displayed based on a user's history.

20. The one or more computer-readable storage devices of claim 16, wherein the plurality of instructions cause the processor to promote lower ranked views.
